(19) United States
(12) Patent Application Publication
(10) Pub. No.: US 2025/0041767 A1
(43) Pub. Date: Feb. 6, 2025

(54) Apparatus

(71) Applicant: HYDAC Systems & Services GmbH, Sulzbach / Saar (DE)

(72) Inventors: Michael Scheidt, Riegelsberg (DE); Andreas Neurohr, Spiesen-Elversberg (DE)

(73) Assignee: HYDAC Systems & Services GmbH, Sulzbach / Saar (DE)

(21) Appl. No.: 18/716,288

(22) PCT Filed: Nov. 29, 2022
(86) PCT No.: PCT/EP2022/083625

§ 371 Date: Jun. 4, 2024

(30) Foreign Application Priority Data
Dec. 9, 2021 (DE) 10 2021 006 066.0

(51) Int. Cl. B01D 25/19; F15B 11/22; F15B 15/28

(52) U.S. Cl. CPC B01D 25/19; F15B 11/22; F15B 15/2838; F15B 2211/20515; F15B 2211/6336

(57) ABSTRACT

Disclosed is an apparatus for moving a plate in opposite directions using a plurality of hydraulic actuators wherein at least one possible inclination of the plate relative to a specifiable reference plane is monitored by means of a sensor device which controls the actuators in such a way that the plate takes the position of the reference plane.

### CROSS-REFERENCE TO RELATED APPLICATIONS

This application claims priority to German Patent Application No. DE 10 2021 006 066.0, filed on Dec. 9, 2021 with the German Patent and Trademark Office. The contents of the aforesaid patent application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The invention relates to an apparatus for moving a plate in opposite directions using a plurality of hydraulic actuators.

WO 2020/177105 A1 discloses a pressing device in the form of a horizontal filter press with a plurality of plates running in parallel with one another, which are designed in the form of a plate stack oriented along a horizontally extending reference plane in each case. As part of a filtration process, slurry is supplied to the filter press, wherein the solid particles in the slurry are deposited between the plates as filter cake, and the liquid arising by pressing together the respective filter cake by means of the plates is discharged from the pressing device, wherein the filter cake and/or the liquid may be the filtration end product required in each situation.

In order to move the plates together and to better press the resulting filter cake, hydraulic operating cylinders act as actuators with which very high pressing forces can be exerted on the plate stack. Electric servomotors are used to move the plates in the plate stack apart from one another after carrying out filtration because higher opening speeds are expected of such motors. To ensure seamless filtration operation, it is particularly important that the plates are arranged horizontally inside the correspondingly extending reference plane and are not inadvertently inclined.

### SUMMARY

A need exists to improve such technology. The need is addressed by the subject matter of the independent claim(s). Embodiments of the invention are described in the dependent claims, the following description, and the drawings.

### BRIEF DESCRIPTION OF THE DRAWINGS

FIG. 1 shows an example perspective plan view of a horizontally extending plate to be controlled by actuators, beneath which an inclination sensor is attached in relation to the plate orientation with the longitudinal edges thereof;

FIG. 2 shows an example, highly simplified representation of the possible deflection of the horizontally extending plate according to FIG. 1 from this reference plane into a position inclined in two directions, wherein the plate inclined in this manner is reproduced by a dashed line;

FIGS. 3 and 4 are highly simplified representations of an example control structure for a master operating cylinder or for slave operating cylinders respectively;

FIG. 5 shows a simplified, example representation of the components of a hydraulic circuit diagram to explain the pressure supply for the individual hydraulic actuators;

FIG. 6 shows an example hydraulic pressure supply for the operating cylinder shown to the far left in FIG. 5 for improved viewing purposes; and

FIG. 7 shows an example perspective plan view showing the hydraulic components of the apparatus combined in a transport rack for presentation to a machine, such as a pressing device (not shown).

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, at least one possible inclination of a plate relative to a specifiable reference plane is monitored by means of a sensor device which controls the actuators, in particular by using an adjustment device, in such a way that the plate assumes or retains the position of the reference plane. A synchronous operation for the actuators is performed such that the aforementioned plate always resumes its original position in the specifiable reference plane in the event of any undesirable deflection in inclination. For example, it is controlled such that, in the event of any inclination forces arising on the plate, compensation takes place immediately and the plate retains its original position, for example in a horizontal orientation. If the aforementioned plate forms part of a plate stack, the orientation of subsequent plates in the plate stack is oriented towards the orientation of the first plate, which is controlled by the actuators using the sensor device, by means of a corresponding individual plate guide. In this process, as part of the synchronous operation, the individual actuators are controlled and extended differently by means of an adjustment device such that the horizontal orientation is restored immediately and the sensor device detects the current position of the plate in the specified reference planes, which terminates the adjustment process.

Each actuator may comprise a motor-pump unit for corresponding control purposes, wherein one of the actuators acts as the master and the other actuators act as slaves in relation thereto. Such master-slave systems represent a kind of hierarchical access management to a shared resource, usually in the form of a shared data or supply channel, making it easier to control the individual actuators synchronously as part of the desired adjustment operation in order to restore a plate that is inclined or deflected respectively to any extent into its original position within the specifiable reference plane, or to retain the plate in this position.

For example, the apparatus in this case comprises an inclination sensor as part of the sensor device, which includes a biaxial measurement system for recording the inclination of the plate in relation to the reference plane and is attached to the plate in such a way that the inclination directions to be recorded are perpendicular to one another and are in each case oriented parallel 25 to the plate edges of the plate, which for example comprises a rectangular basic outline.

In addition to a biaxial measurement system for recording the current inclination of the plate, in relation to a specifiable reference plane, such as a horizontal plane, triaxial acceleration sensors may also be incorporated to calculate the inclination signal in the quasi-static state, i.e., at rest. In order to calculate the inclination as part of dynamic processes, a rotation rate sensor is also provided and by combining the two physically independent measurement signals for acceleration and rotation rate it is possible to calculate a movement-compensated inclination signal. In this process, for appropriate adjustment and measured value acquisition, it is essential to ensure that the orientation of the inclination sensor corresponds to the orientation of the plate to be monitored. Corresponding information sensors generally have CAN interfaces.

In some embodiments, it is provided that the respective actuator is designed as a hydraulic operating cylinder, that a speed adjustment facility is provided for the master cylinder and a position adjustment facility is provided for the slave cylinders, that the motor-pump unit for the master cylinder is operated at a constant speed and the respective extended position of the master cylinder is monitored by a monitoring device, and that the respective extended position of the slave cylinders is calculated by means of a geometric model using measurement data from the inclination sensor. As a result, the adjustment task can be completed particularly quickly with two different adjustment concepts, firstly in the form of speed adjustment, and secondly in the form of position adjustment, in that a plate with any inclination returns to its specifiable, for example horizontally extending reference plane as quickly as possible. A PI controller is provided to adjust the speed of the master cylinder and a P controller is also provided to adjust the position of the slave cylinders.

In some embodiments, it is provided that, once the specifiable reference plane has been reached, all actuators are switched to pressure regulation to exert a feed force on the plate. As soon as the inclination of the plate has been compensated and this has once again returned to its horizontal reference plane, all actuators, i.e., operating cylinders, are uniformly loaded with pressurised fluid originating from an associated supply source in order to be able to apply a uniform filtration pressure on the respective filter cake in the plate stack in this manner.

In some embodiments, it is provided that the respective actuator is connected to a hydraulic supply circuit, which, in addition to the motor-pump unit, comprises at least one changeover valve to switch the direction of motion of the respective actuator plus a load-holding valve and a discharge device for returning fluid, in particular to a storage tank. For example, all hydraulic supply circuits are designed in the same way in this process, in particular having the same number and type of valves. In this manner, the inclination adjustment can be achieved via the respective actuator with standard hydraulic components, such as hydraulic valves with a simple design, and, furthermore, for the actual pressing operation, the feed movement of the plate and the return of said plate in the opposite direction can be carried out into a source position in which the filter cake can be removed from the press.

It is beneficial that all key hydraulic components for the hydraulic supply circuits are received in a transport rack which is provided to a pressing device that has at least one plate. In this manner, the apparatus can also be retrofitted to existing presses and requires minimal installation space in this process.

The teachings herein also relates to a pressing device with a plurality of individual, in particular horizontally extending plates, which, as part of a filtration process as a plate stack, each receive between them a filter cake that is to be separated from a process liquid using an apparatus as specified above, wherein an outermost plate in the plate stack comprises the inclination sensor on its side facing away from the adjacent filter cake, wherein the individual actuators engage in a force-transmitting manner on this side.

In connection with horizontal filter presses, the outermost plate in the plate stack may ideally be arranged such that it extends horizontally; however, in the case of vertical presses, it is also possible to align the plate to be controlled vertically in the original state, wherein corresponding vertical presses are regularly used in connection with beverage filtration or in connection with medical/pharmaceutical filtration.

The apparatus does not need to be restricted to the application of presses but can instead always be used where it is necessary to align any kind of plate structure in relation to a specified reference plane. Corresponding plate solutions are also used in connection with transport vehicles and lifting platforms.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS. The FIGS. are not to scale.

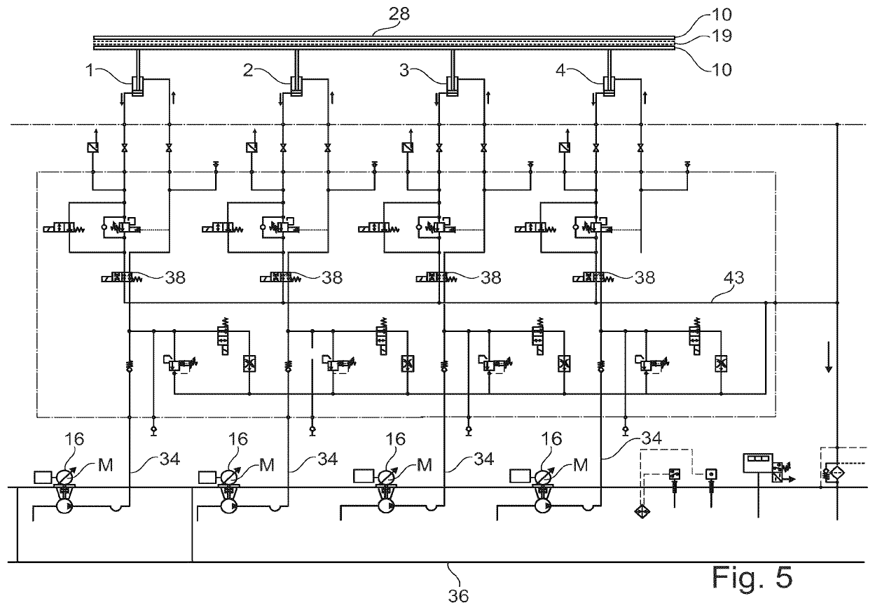

FIG. 1 shows a rectangular plate 10, which is mounted and guided in a movable manner in the opposite direction, i.e. upwards and downwards as shown on FIG. 1, using hydraulic actuators 1, 2, 3, 4. The actuators 1, 2, 3, 4 consist of standard hydraulic operating cylinders, the rod ends of a piston-rod unit 12 of which (FIG. 5) are intended, in an example manner, to engage on the corner points of the rectangular plate 10, which, as shown in FIG. 1, is oriented horizontally in an associated horizontal reference plane. The actuators 1, 2, 3, 4 or the hydraulic operating cylinders respectively are designed in the same way and the plate 10 has edge lengths a and b. An inclination sensor 14 with two possible inclination directions x and y to be recorded is arranged beneath the plate 10, said inclination directions being perpendicular to one another and running parallel to plate side a or to plate side b respectively. For the filtration process, for example in connection with a horizontal filter press, to ensure reliable operation, the plate 10 in its horizontal position as shown in FIG. 1 needs to lie within the specifiable horizontal reference plane.

As already mentioned, an inclination sensor 14 and, if necessary, also a plurality of inclination sensors can be used to monitor the plate orientation, said inclination sensors being able to be purchased commercially under the “HIT 1500” brand name from the proprietor of the property right.

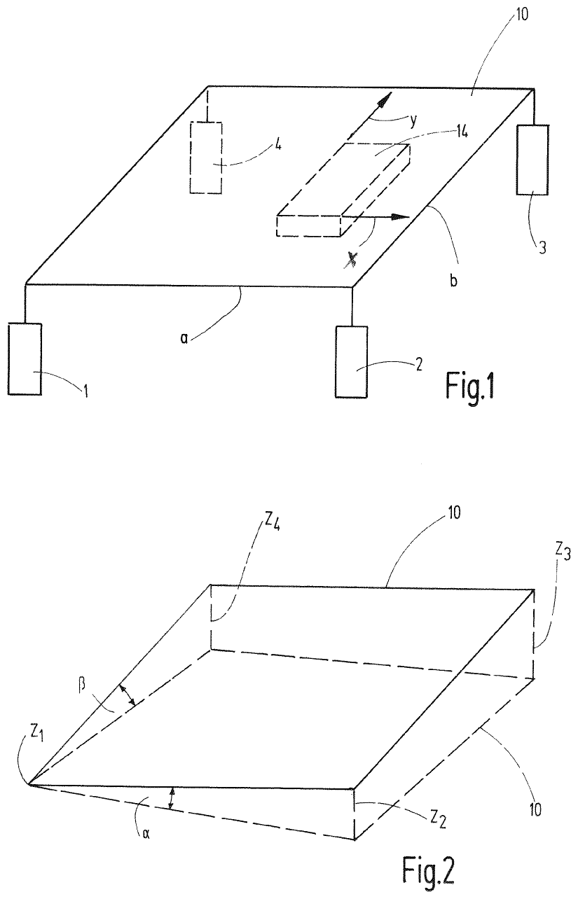

In the model drawing shown in FIG. 2, the table-like plate 10 is now inclined downwards from the horizontal, for example in connection with an inadvertent disturbance due to force being applied, wherein the plate path indicated at the top relates to the ideal situation for horizontal orientation and the plate contour reproduced below by way of dashed lines relates to the inclined situation, in which the inclined plate 10 is inclined downwards and pivoted from the horizontal through both angles of inclination α and β around the articulation point z₁. While no change occurs at the point of rotation z₁ viewed in the vertical longitudinal direction, a vertical linear offset z₂, z₃ and z₄ arises due to the inclination of the plates 10 downwards. The corresponding view is idealised, but still applies for further adjustment considerations in accordance with the basic principle. Due to its arrangement on the plate 10, the aforementioned inclination sensor 14 is now in a position to measure the angles of inclination α and β. The individual changes in height z₂, z₃ and z₄ can then be determined as follows by geometric means using triangulation calculations in the conventional manner as follows:

$${z}_{2} = a \cdot tan α$$

$${z}_{4} = b \cdot tan β$$

$${z}_{3} = \sqrt{{a}^{2} + {b}^{2}} \cdot tan ( ar cos ( \frac{\sqrt{{a}^{2} + {b}^{2}}}{\sqrt{{( \frac{a}{cos α} )}^{2} + {( \frac{b}{cos β} )}^{2}}} ) )$$

If the plate 10 is then to be moved out of its inclined lower position into the upper horizontal position, this means that the actuator 1 needs to retain its position but that the actuators 2, 3 and 4 have to move through the differential paths 22, z₃ and z₄ by extending with their piston-rod units 12 accordingly so that an actuator view according to FIG. 1 is once again obtained. If, with reference to a disturbance, the aforementioned inclination of the plate 10 through the angles α and β occurs, the piston-rod units 12 of the actuators 1, 2, 3, 4, which are otherwise arranged in a stationary manner, retract and, in order to compensate, the actuators 1, 2, 3, 4 then have to extend again, specifically by the aforementioned paths z₂, z₃ and z₄ in each case in order to return the plate 10 back to the intended horizontal inclination. With regard to the paths to be covered in this case, the formulae specified above are used, as these incorporate the geometry of the plate 10 and its inclination by including the angles of inclination α and β measured and calculated by the inclination sensor 14.

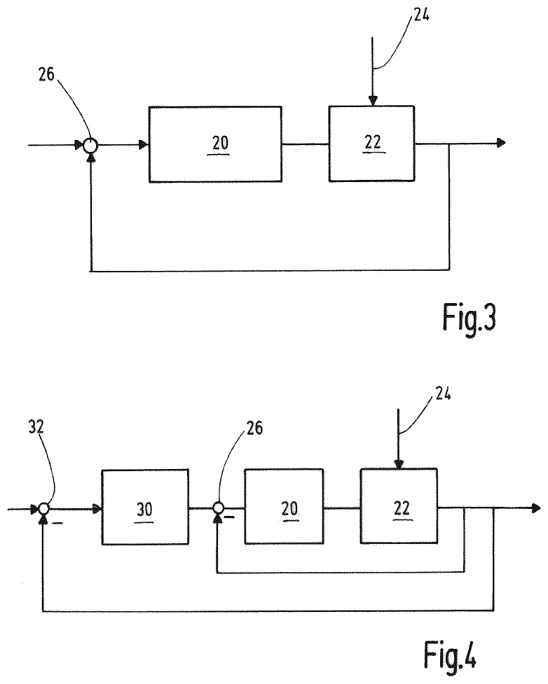

FIG. 3 shows a simplified representation of the adjustment for the actuator 1 acting as a master cylinder, the motor-pump unit 16 of which is operated at a constant speed as a so-called master axle, wherein the position of the actuator 1 can thus be calculated by the displacement principle of the unit 16 and the calculated value can be compared for every stroke of the actuator 1 by limit switches or pressure switches 18 respectively (FIG. 5). In this manner, the parameters are also adapted and they are checked to establish whether they are meaningful before the data is saved and reused in connection with the aforementioned adjustment. In this process, a PI controller acting on an actuating element is referred to in FIG. 3 as 20, said controller acting on the output side on the control path 22 that may be subject to disturbances 24. The actual speed is then recorded on the output side of the control path 22 and said speed is returned to a comparison point 26 with a negative initial value as part of the control circuit, a comparison between the desired target speed and the actual speed taking place at the comparison point 26 and the resulting difference being passed on to the input side of the PI controller 20.

The position of the three other axles of the actuators 2, 3, 4 is established via the geometric model as mentioned above by incorporating the horizontal reference plane and the measurement data from HIT 1500 is calculated along with the angles of inclination α and β in the inclination directions x and y. By means of factors that are not described in greater detail, the differences in position from the master axle of the actuator 1 can be weighted and the speed can be increased or reduced accordingly such that the actuators 2, 3, 4 cover the paths z₂, z₃ and z₄ and in so doing return the deflected inclined plate 10 back into its horizontal position. The corresponding return of the plate 10 is constantly monitored via the inclination sensor 14, which in turn influences the actuators 2, 3, 4 in their actuation state via the aforementioned adjustments. On reaching the horizontal end position of the plate 10, all four axles of the actuators 1, 2, 3 and 4 are then switched to pressure regulation such that the plate 10 for the aforementioned filtration process is able to press the overlying filter cake 19 in the plate stack 28 (FIG. 5) together. FIG. 5 shows only a lower part of a plate stack 28 and it is clear that a plurality of plates 10 lying one on top of the other with filter cakes 19 lying therebetween make up the plate stack 28 in its entirety, as disclosed in citation WO 2020/177105 A1, for example.

As shown in the drawing in FIG. 4, the speed adjustment illustrated in FIG. 3 for the respective slave cylinders 2, 3, 4 is supplemented by a further simple P controller 30 in order to obtain an adequate stationary accuracy in this manner. In this process, the current position value z₂ or z₃ or z₄ obtained at the output of the control loop 22 is returned to the further comparison point 32 with a minus sign and then compared here with a predefined zero value on the input side, and the difference is then passed to the P controller 30 as an input variable. To ensure reliable adjustment, the speed controller used needs to be identical for all master and slave actuators 1, 2, 3, 4.

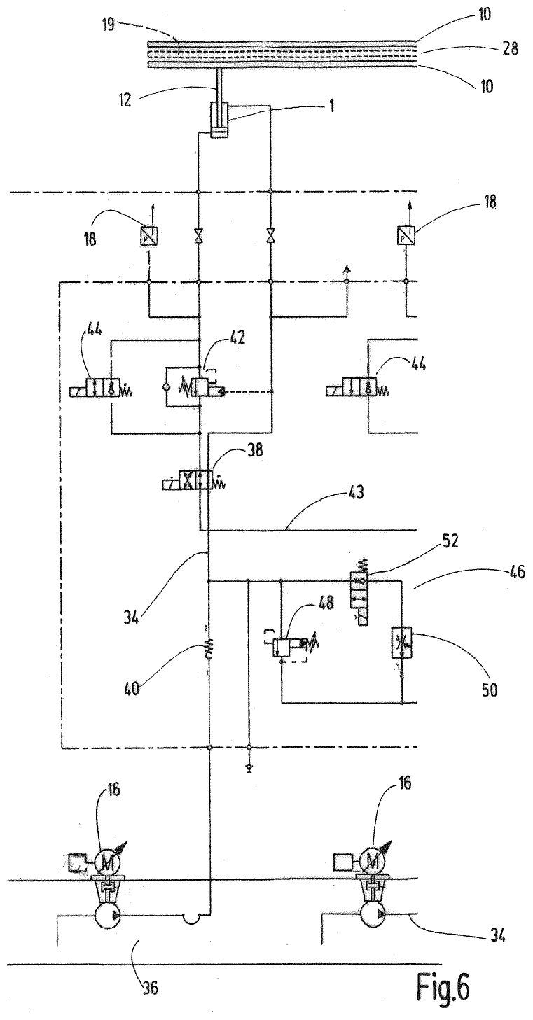

The hydraulic supply for the individual actuators 1, 2, 3, 4 is now described in further detail below by means of FIGS. 5 and 6, where, for the sake of simplicity, more reference is made to FIG. 6, which, as viewed in the direction of FIG. 1, shows the left-hand master cylinder 1 which is designed as a differential cylinder and has the displaceable piston-rod unit 12, the rod end engaging on the lower side of the plate 10. In the form of a plate stack 28, a further horizontally arranged plate 10 is provided on top and the two plates 10 receive the filter cake 19 to be pressed out between them. The actuator 1 is connected on both the piston side and the rod side to the motor-pump unit 16 by means of a hydraulic supply circuit 34, wherein the motor is designed as an electric motor and controlled by the speed adjustment facility in accordance with the drawing shown in FIG. 3. The pump conveys fluid from a storage tank 36 of the usual design and the actuator can be retracted and extended in the usual manner by means of a changeover valve 38. In the illustrated switching position of the valve 38, fluid passes at a pre-definable pressure from the motor-pump unit 16, opening a spring-loaded non-return valve 40 on the rod side of the cylinder 1 such that this retracts. A safety check valve 42 is connected in a fluid line originating from the piston side of the actuator 1, said safety check valve being designed as a load-holding valve to prevent loads on the actuator 1 being able to lead to uncontrolled lowering. To this end, they are pretensioned with a pressure setting which is for example higher than the largest possible load to be expected on the actuator 1. The fluid displaced from the actuator 1 on the piston side passes via the changeover valve 38 to the tank side via a conventional discharge device 43 of the overall apparatus. A further bypass valve 44 is connected parallel to the safety check valve 42 in the hydraulic supply circuit 34, said bypass valve short-circuiting the valve 42 in the actuated state by bypassing.

A safety block 46 is also connected on the inflow side into the hydraulic supply circuit 34 with a pressure-limiting valve 48 and a flow control valve 50. The flow control valve 50 can, if necessary, be switched by actuating a sequence valve 52. The corresponding structure of hydraulic supply circuits 34 is standard, with the result that no further detail is provided at this juncture.

However, as is shown in FIG. 5 in particular, the hydraulic supply circuit 34 illustrated for the master cylinder 1 in FIG. 6 is also provided for the further slave cylinders 2, 3 and 4, with the result that the corresponding valve and control structure is identical; however, this is subject to the proviso that the motor-pump units 16 for the slave cylinders 2, 3, 4, receive their position adjustment via the control circuit shown in FIG. 4. Overall, the disclosed apparatus solution allows four differential cylinders 1, 2, 3, 4, each with a frequency-controlled motor-pump unit 16, to operate synchronously, said motor-pump unit being provided for each differential cylinder 1, 2, 3, 4. Furthermore, an angle of inclination sensor (HIT) 14 is used and, as a function of the tilt of the first filter mat or filter cake 19, respectively, the inclined position or tilt of the bottommost plate 10 is recorded by means of the angle of inclination sensor 14, specifically in inclination directions x and y. As a function of the corresponding inclination values α and β in the x and y direction, the speed values for the four frequency-controlled motor-pump units (4 DVA kits) 16 are then adjusted to allow the differential cylinders 1, 2, 3, 4 to extend more quickly or more slowly and thus ensure synchronous movement of all cylinders so as to in turn achieve a horizontal orientation of the plate 10 and filter cake 19 as promptly as possible and accordingly a horizontal orientation of all subsequent plates 10 in the plate stack 28.

Overall, this is thus a hydraulic displacement control with an internal gear pump with a constant supply volume, which directly controls the displacement motion of the respective differential cylinder 1, 2, 3, 4 by returning the signal from the angle of inclination sensor 14 in a closed control circuit, as is shown in outline in FIGS. 3 and 4.

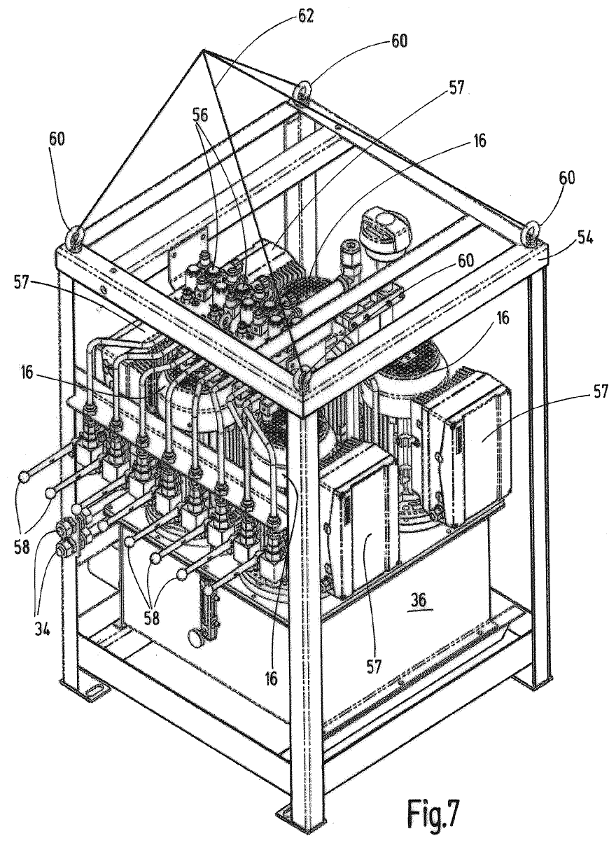

FIG. 7 shows the hydraulic components combined in a transport rack 54 with the four motor-pump units 16 and the aforementioned control valves, which are combined in one or more valve blocks 58. Furthermore, the respective motor-pump unit 16 sits on the storage tank 36. Furthermore, a power electronics system 57 is attached to the respective motor-pump unit 16, said system also including the controls to control the motor-pump units 16 as a function of the inclination values from the inclination sensor 14. The hydraulic lines for individual hydraulic supply circuits 34 lead by means of individual block taps 58 that can be blocked at least partially on the front side from the transport rack 54. The transport rack 54 is furnished with lifting eyes 60 on its upper rack side such that the apparatus as a whole, along with its hydraulic components, can be brought in a simple manner by means of a hoist 62 of a crane to positions in the vicinity of a pressing device, as disclosed in WO 2020/177105 A1, for example.

As all hydraulic supply circuits 34 with their units 16 and the specified valves are designed in the same way, this ensures reduced manufacturing costs and increased functional reliability due to the use of identical components.

In addition to the aforementioned hydraulic operating cylinders, the respective actuator 1, 2, 3, 4 may also be an electromechanical drive unit, in particular in the form of a spindle drive.

The respective actuator 1, 2, 3, 4 is connected to the hydraulic supply circuit 34 which, in addition to the motor-pump unit 16, comprises at least one control valve (not shown) to adjust the position of the respective actuator 1, 2, 3, 4.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. An apparatus for moving a plate in opposite directions using a plurality of hydraulic actuators, wherein at least one possible inclination of the plate relative to a specifiable reference plane is monitored using a sensor which controls the actuators in such a way that the plate takes the position of the reference plane.

12. The apparatus of claim 11, wherein each actuator comprises a motor-pump unit for control purposes and wherein one of the actuators acts as the master and the other actuators act as slaves in relation thereto.

13. The apparatus of claim 11, wherein the sensor comprises an inclination sensor, which includes a biaxial measurement system for recording the inclination of the plate with reference to a reference plane and which is attached to the plate in such a way that the inclination directions to be recorded are perpendicular to one another and are in each case oriented parallel to the plate edges of the plate.

14. The apparatus of claim 11, wherein the respective actuator is configured as a hydraulic operating cylinder, wherein a speed adjustment facility is provided for the master cylinder and a position adjustment facility is provided for the slave cylinders, wherein the motor-pump unit for the master cylinder is operated at a constant speed and the respective extended position of the master cylinder is monitored by a monitoring processor, and wherein the respective extended position of the slave cylinders is calculated using a geometric model using measurement data from the inclination sensor.

15. The apparatus of claim 11, wherein a PI controller is used to adjust the speed of the master cylinder and a P controller is used to adjust the position of the respective slave cylinders.

16. The apparatus of claim 11, wherein, once the specifiable reference plane has been reached, all actuators are switched to pressure control to exert a feed force on the plate and to force control when creating an electromechanical solution.

17. The apparatus of claim 12, wherein the respective actuator is connected to a hydraulic supply circuit, which, in addition to the motor-pump unit, comprises at least one changeover valve to switch the direction of motion of the respective actuator and a load-holding valve and a discharge device for returning fluid.

18. The apparatus of claim 11, wherein the hydraulic supply circuits are configured similarly.

19. The apparatus of claim 11, wherein all key hydraulic components for the hydraulic supply circuits are received in a transport rack, which is provided to a pressing device that has at least the one plate.

20. A pressing device with a plurality of individual, in particular horizontally extending plates, which, as part of a filtration process as a plate stack, each receive between them a filter cake that is to be separated from a process liquid, with an apparatus according to claim 1, wherein an outermost plate in the plate stack comprises an inclination sensor on its side facing away from the adjacent filter cake and wherein the individual actuators engage in a force-transmitting manner on this side.

21. The pressing device of claim 20, wherein each actuator comprises a motor-pump unit for control purposes and wherein one of the actuators acts as the master and the other actuators act as slaves in relation thereto.

22. The pressing device of claim 20, wherein the inclination sensor includes a biaxial measurement system for recording the inclination of the plate with reference to a reference plane and which is attached to the plate in such a way that the inclination directions to be recorded are perpendicular to one another and are in each case oriented parallel to the plate edges of the plate.

23. The pressing device of claim 20, wherein the respective actuator is configured as a hydraulic operating cylinder, wherein a speed adjustment facility is provided for the master cylinder and a position adjustment facility is provided for the slave cylinders, wherein the motor-pump unit for the master cylinder is operated at a constant speed and the respective extended position of the master cylinder is monitored by a monitoring processor, and wherein the respective extended position of the slave cylinders is calculated using a geometric model using measurement data from the inclination sensor.

24. The pressing device of claim 20, wherein a PI controller is used to adjust the speed of the master cylinder and a P controller is used to adjust the position of the respective slave cylinders.

25. The pressing device of claim 20, wherein, once the specifiable reference plane has been reached, all actuators are switched to pressure control to exert a feed force on the plate and to force control when creating an electromechanical solution.

26. The pressing device of claim 21, wherein the respective actuator is connected to a hydraulic supply circuit, which, in addition to the motor-pump unit, comprises at least one changeover valve to switch the direction of motion of the respective actuator and a load-holding valve and a discharge device for returning fluid.

27. The pressing device of claim 20, wherein the hydraulic supply circuits are configured similarly.

28. The apparatus of claim 11, wherein the plate comprises a rectangular basic outline.

29. The apparatus of claim 17, wherein the discharge device is configured to return fluid to a storage tank.

30. The apparatus of claim 19, wherein the hydraulic supply circuits have the same number and type of valves.
